(19) United States
(12) Patent Application Publication
(10) Pub. No.: US 2009/0069120 A1
(43) Pub. Date: Mar. 12, 2009

(54) Golf round pace regulator

(76) Inventor: Ellen Mosher, Alexandria, VA (US)

Correspondence Address: ELLEN MOSHER, 324 North Saint Asaph Street, Alexandria, VA, 22314, US

(21) Appl. No.: 12/068,574

(22) Filed: Feb. 8, 2008

Related U.S. Application Data
(60) Provisional application No. 60/935,916, filed on Sep. 6, 2007.

(51) Int. Cl. A63B 57/00; G07C 1/22

(52) U.S. Cl. 473/409; 368/76; 368/291; 368/286

(57) ABSTRACT

Embodiments of a Golf Round Pace Regulator timing device is shown and described. The timer, with a custom course specific face decal, illustrates the time allocated to each hole on the golf course to help golfers maintain a steady pace of play to complete the course in the time allotted by the golf course management. The golfer(s) are responsible for maintaining the same pace on the course as the pace of the timer's moving clock hand across the easy to read face decal. The timer solves the problem of slow play and decreased course revenue due to slow play. The timer solves the expensive customization manufacturing problem since it may be mass produced, and after manufacturing the customized course decal may be created and applied. The Timer is easy to implement and use on any golf course.

### CROSS-REFERENCE TO RELATED APPLICATIONS

Reference to provisional patent application No. U.S.60,935,916 filed Sep. 6, 2007.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Each golf course agent determines the amount of time golfers are given to complete the course. However, golf course agents do not provide golfers with the amount of time golfers are allocated for each hole on the course so golfers start playing the game slowly and never start a good pace to complete the course within the time allotment resulting in a bottleneck affect on the course termed “Slow Play”. The purpose of the Golf Round Pace Regulator timing device is to enforce the course time allotment by providing a device capable of illustrating time allotted for each hole so golfers can easily monitor their pace of play by keeping the same pace of play as displayed on the Timer. This Timer will keep play at a steady pace to minimize congestion, delay and frustration on the course. By providing a device that golfers can use to maintain their pace of play, golf course management can now enforce the posted course time and restrict slow players from their golf course. Golf course management can stay on schedule to allow players to start play at their reserved tee times. Slow play results in reduced golfers on the course. With a regulated pace of play, golf course management can maximize players on the golf course, thereby improving golf revenues.

An earlier version of a timing system is disclosed in “System and Method of Timing Golfers on a Golf Course” by Wolfe, U.S. Pat. No. 4,303,243, issued Dec. 1, 1981. This system allows the users to determine whether or not they are playing according to a prescribed time limit for each hole, as well as comparing their playing pace to other groups on the course. The timers indicate whether the golfers played the preceding hole faster, slower, or equal to the predetermined playing time. Unfortunately, the device does not display the timing for a current hole, but rather the display is made on the succeeding tee box.

Another tracking method is the “System for Monitoring Play of a Golfer” of Mathews, U.S. Pat. Nos. 5,086,390 and 5,097,416, issued Feb. 4, 1992, and Mar. 17, 1992 respectively. This system utilizes transmitters positioned at the tees of each of the holes of the course to activate receivers carried by the golfers. The system also includes a means of notifying the course management of slow players. This device needs to be installed on the golf course.

The “Golf Clock” of Bartos, U.S. Pat. No. 5,335,212, issued Aug. 2, 1994, is another example of a programmable clock device. This device includes a digital display and is intended to be mounted on the user's golf cart. This device does not easily illustrate the time allotted each hole in order to maintain a steady course pace. Also, the device is not portable, so it cannot be used on a pull cart or golf bag for those players walling the course.

Accordingly, there have been many efforts made in terms of prior art devices that track and/or notify golfers of the pace of their play One such device is the “Variable Time Segment Pace Timing Device” of Coleman, U.S. Pat. No. 5,357,487, issued Oct. 18, 1994. The device includes a plurality of timing elements that can be programmed for the amount of time that the player desires to be allotted for each hole of the course. The timing can be varied to allow for changing conditions including number of players in a group and daylight hours available. The device is to be carried by at least one of the golfers. This device needs to be programmed with each use therefore human error jeopardizes the accuracy of the device.

Smith, U.S. Pat No. 5,386,990 discloses Still another timing device is the “Golf Course Timing Method and System” of Smith, U.S. Pat. No. 5,386,990, issued Feb. 7, 1995. This device includes provisions for specifying the time to be allotted for each hole, for tracking the time of play, and for communicating the information to course personnel. The device is a series of moveable blades to be adjusted by the golf attendant therefore human error jeopardizes the accuracy of the device.

Another device to time play is the “Golf Course Timer to Alleviate Slow Play” of Nixon, U.S. Pat. No. 5,523,985, issued Jun. 4, 1996. This device is worn like a wristwatch by the golfer, and includes means to set the desired time to complete the round. The hour indicators of a normal wristwatch are replaced with the numbers of the holes of the golf course. A wristwatch device is a physical distraction for some when playing golf and is adjustable by the player not course management.

“The Golf Play Pacing Method” of Rege, U.S. Pat. No. 6,346,055 issued February 2002, is to provide a golf play pacing method that utilizes a device that is mounted directly in the flag sticks of the golf course and provides a pacing means that is dependent on the real-time playing interval for each hole relative to the pace on the course. This device needs to be installed on the golf course.

The prior art devices and methods for pacing are subject to one or more of the following shortcomings: First, the prior art assumes a willingness of the players themselves to adjust and activate the devices. Without golf course management controlling the devices, the players may readjust the device during play as needed.

Another drawback to prior art devices and methods is that they are dependent on the golf management manually adjusting each timer and monitoring each timer to ensure 18 moveable parts have not slipped out of place. With over 100 devices on the course, this is too tedious and human error can result in incorrect time allocations.

Another drawback to prior art devices and methods is that they are not easy to read, user friendly and do not encourage use. Display boards or clocks posted at tee boxes may be unnoticed by the golfers.

Another drawback to prior art devices and methods is they are permanently installed on golf courses and must be monitored and maintained by golf management to ensure not damaged by weather, lawn care devices and/or animals.

Another drawback to prior art devices and methods is they are complicated devices that actually spoil the golf game, therefore will not be used by golfers.

The current art is an effective, accurate, durable, and a tamperproof device for encouraging steady play on golf courses that is easy for the golf course management to implement use, easy for the course starter to activate, easy to manufacture, easy to customize for each golf course, and easy for players to monitor their pace of play. The current art does not require timers at every tee or flag pole, complex electronic communications equipment, or a timer with 18 moving parts that need to be manually adjusted to be correct.

### BRIEF SUMMARY OF THE INVENTION

Each golf course agent determines the amount of time golfers are given to complete the course. However, golf course agents do not provide golfers with the amount of time golfers are allocated for each hole on the course so golfers start playing the game slowly and never start a good pace to complete the course within the time allotment resulting in a bottleneck affect on the course termed “Slow Play”. The purpose of the Golf Round Pace Regulator timing device is to enforce the course time allotment by providing a device capable of illustrating time allotted for each hole so golfers can easily monitor their pace of play by keeping the same pace of play as displayed on the Timer. This Timer will keep play at a steady pace to minimize congestion, delay and frustration on the course. By providing a device that golfers can use to maintain their pace of play, golf course management can now enforce the posted course time and restrict slow players from their golf course. Golf course management can stay on schedule to allow players to start play at their reserved tee times. Slow play results in reduced golfers on the course. With a regulated pace of play, golf course management can maximize players on the golf course, thereby improving golf revenues.

The current art is an effective, accurate, durable, and a tamperproof device for encouraging steady play on golf courses that is easy for the golf course management to implement use, easy for the course starter to activate, easy to manufacture, easy to customize for each golf course, and easy for players to monitor their pace of play. The current art does not require timers at every tee or flag pole, complex electronic communications equipment, or a timer with 18 moving parts that need to be manually adjusted to be correct.

My timer is a universal design that may be mass produced. After production, the custom course cling static decal may be printed and applied. The timer may be used on any course worldwide. The uniqueness of the custom course cling static decal is that does not need glue or any other adhesive material to adhere to the timer. Once the timer has been produced, the decal may be printed with the course specific information, applied to the timer, and shipped to the course to be used right out of the box.

The cling static decal only adheres to glass, so the glass surface protecting the timer from moisture, is where the decal is applied. The timer has a durable poly-carbonate top bezel that snaps to the glass bezel to protect the glass from breakage and prevents players from removing the decal.

The timer's timing mechanism can only be reset with a special key given to golf management. The key resets the timer to the start position and cannot be partially reset to any other position. Once the timer has been reset, and the players have teed off, the starter starts the timer by pressing the start button. The key is not available to golfers in order to prevent tampering with the timer. Once the timer has started, golfers cannot reset, adjust or stop it.

The timer runs on a battery. The battery compartment may only be opened with a special key given to golf management. Golfers do not have access to this key so they cannot tamper with the power to stop the timer. At the end of the golf game, the timer will stop. To save power, the battery is not in use when the timer is stopped.

The timer is water resistant and capable of withstanding varying weather conditions to include but not limited to heat, cold, dampness, humidity, wind etc.

The timer is tamper proof thereby guaranteeing consistency and reliability of the timing device, and performing as intended to provide golfers with a pace guide to keep on pace with posted golf course time.

The timer is easy to view, understand and use thereby ensuring golfers are aware of their pace on the golf course. The timer may be attached to a golf bag, pull cart, power cart and/or attached to the golfer or caddy.

The timer usage is easy to implement on any course. The timer does not require expensive computers or monitoring systems to be implemented to use the device. The timer does not need equipment installed on golf course to transmit signals anywhere.

The timer enables golfers to maintain the posted pace of play thereby providing a more enjoyable game for all players. Golf course management that provides a course that is free from “slow play” benefits from more tee times from golfers who don't like “slow play” courses.

### BRIEF DESCRIPTION OF THE SEVERAL VIEWS OF THE DRAWING

The following drawings, which are incorporated in and constitute a part of the specification, serve to explain the principles of the present invention when they are taken together with the general description given above and the detailed description of the preferred embodiments given below. Moreover, the aforementioned objects and advantages of the present invention, as well as additional objects and advantages thereof, will become apparent when consideration is given to the following detailed description which should be read in conjunction with the following drawings wherein:

FIG. 1—View of the Front of the present invention

FIG. 2—View of the Back of the present invention

FIG. 3—View from the Top of the present invention

FIG. 4—Custom course cling static decal example

### DETAILED DESCRIPTION OF THE INVENTION

General information and Using the Timer:

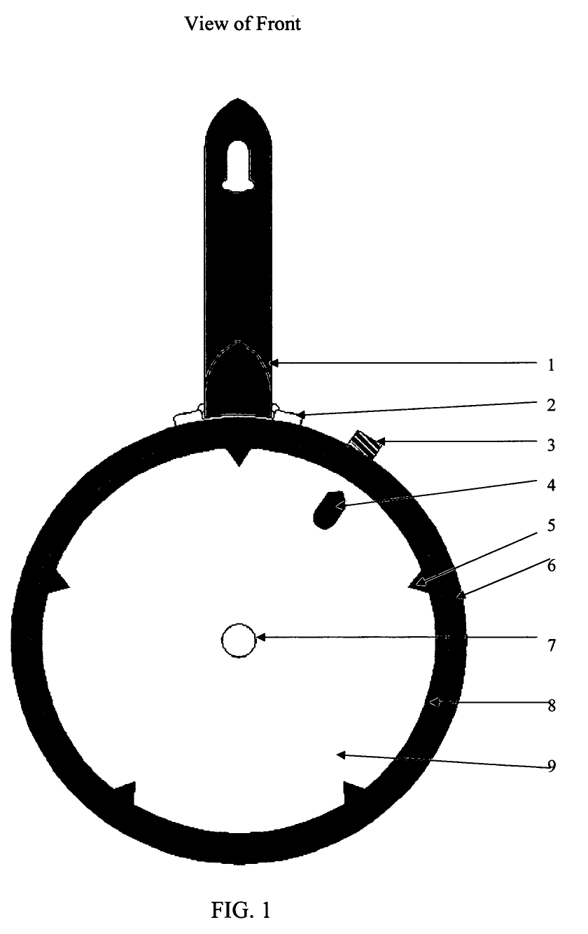

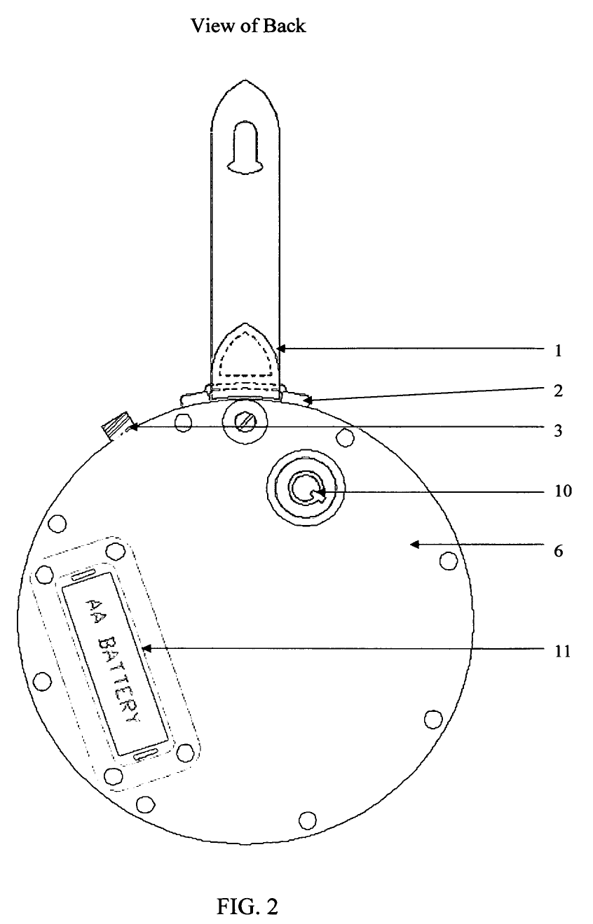

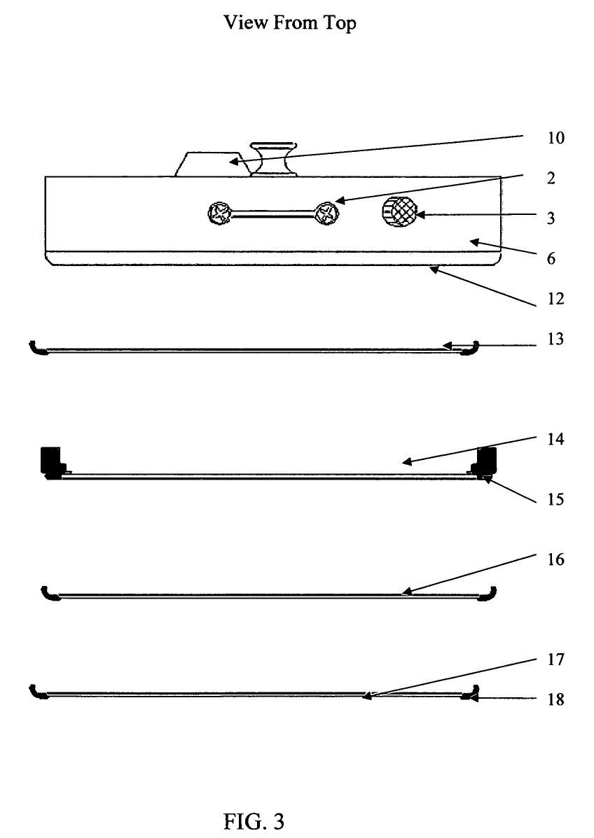

Referring to FIGS. 1-4, there are shown some, but not the only, embodiments of the invented golf round pace regulator. The timer is designed to run 5 hours or 300 minutes then stops on its' own FIG. 1. The red indicator 4 will make one revolution in that period, starting and stopping at the 12:00 position. The movement is based on a clock movement that has been incorporated into a mechanical mechanism which then provides the needed functions. It runs on an AA battery 11, which is installed through a hatch on the back on the timer. FIG. 2. The timer controls 10 are only operable with a custom key, and it will be fairly difficult for a golfer to tamper with the timer once it has been started by the course attendant. The timer is fairly water resistant. FIG. 3 The glass cover 14 is sealed to the case 6 with a standard O-ring seal 15. The battery hatch 11 will also have a gasket. The lock 10 itself is probably not water tight, but should be adequate to resist the entrance of rain etc. The timer is mobile, has an independent power source, easy to implement on any golf course, tamperproof, and water resistant,

FIG. 1 The Outward Appearance is very streamlined. The dial 12 only shows the floating indicator 4 and the 5 hour markers 5. More markers can be added to further breakdown the time increments—perhaps into 15 minute intervals. The marker shapes can be changed as well. The strap 1 works to attach the timer to a bag, cart or pull cart. The circle in the middle of the dial 7 represents the hub that carries the floating transparent disk 13 that has the floating indicator 4. It would be the same color as the dial, so what you would see of it would mostly be based on the shadow it might cast. From a distance it should blend in invisibly. The timer is easy to read, easy to follow, easy to understand, easy to attach to bag, pull cart or power cart, and does not harm the golf course with permanently installed posts.

FIG. 2 Operation of the timer is fairly consistent with regard to the steps taken by the course attendant to prepare and start the timer before handing it to the golfer. The attendant uses the key to turn the lock 10 clockwise approximately 90 degrees. FIG. 1 At that point the floating indicator 4 will be returned to the 12:00 position and the start button 3 will pop out of the side of the case at the 1:00 position viewed from the front. The key is then turned back and removed. The key can only be removed when the lock is turned fully counter clockwise. The timer is now ready for a round of golf. When the moment comes to start the timer, the attendant simply pushes the button in 3. The button will push in until it is flush with the surface of the case, and it will remain there until released by the key at the beginning of the next cycle. These steps are the same every time regardless of the position of the floating indicator at the moment the key is inserted. If the timer is allowed to run the full five hours, it will stop itself at the 12:00 position by breaking the electrical contact between the quartz movement and the battery. The timer is tamperproof and durable.

The key lock uses a tubular style key which is only removable in the counter clockwise position. The lock carries a steel cam which is how it operates the functions inside the timer. The tubular style key can withstand a great deal of twisting force, and will not be distorted over time as a flat key might. These locks are available keyed alike, or keyed differently, and could be ordered in perhaps 10 large lots each with a different key. Then a course can order as many as they like, and as long as timers are sent from the same lot, they will be keyed alike for the course attendant.

The Mechanical Function and Materials for Making the Timer:

The use of the quartz movement simplified the prototype design. It is fully within the capabilities of current quartz analog technology to create all of these functions within a single compact movement, with all of the functions driven electronically and controlled by switches—perhaps using a key lock with electrical contacts instead of a cam. There measurements and materials are for the prototype. During the manufacturing phase, these measurements and materials maybe modified.

FIG. 1 The case 6, cover bezels 15 and 18, and button 3 are black acetal plastic. It is a rigid plastic that is tough and impact resistant. The overall case 6 diameter is 5 inches. The case 6 will be finished with a ‘brush’ finish—grain running around the circumference on the sides and concentric circles on the back.

FIG. 3 The outer cover 17 ‘glass’ is 0.040″ thick clear poly-carbonate plastic. It is shatter proof, providing protection for the glass layer underneath 14 as well as providing containment should that layer shatter. The poly-carbonate layer 17 is carried by a bezel 18 that snaps onto the bezel 15 which carries the glass 13. Removal of the top poly-carbonate layer will require the use of a custom tool to wedge the bezel off. A “V” groove at the seam will be provided to guide the tool, and the snap action will be made such that only moderate force is required to release it.

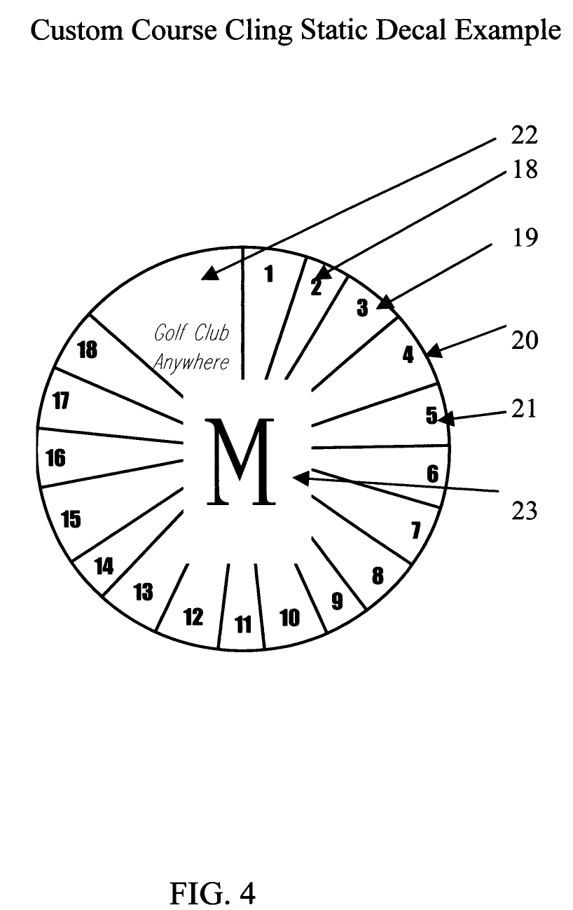

FIG. 3 The custom course cling static decal 16 is placed on the glass cover 14, then protected with the top cover poly-carbonate cover 17. FIG. 4 shows the custom course cling static decal example illustrating the time allocated for each hole on the golf course will be placed on the inner cover glass 14 FIG. 3. The decal is the only piece of the timer not made during the manufacturing phase. The decal will be placed on the timers for that course AFTER the manufacturing phase. This enables the manufacturer to mass produce the timer cost effectively. Once a golf course has placed on order for their timers, the custom course decals will be designed, printed, placed on each timer, and sent to the golf course ready to be used.

FIG. 4 In the timer decal example shown, the timer face is divided into approximately 19 wedges 21. This example is based on the timer have a time limit of 300 minutes or 5 hours. The timer is not limited to 300 minutes or 5 hours. A golf course consists of 18 holes and each hole assigned one of 3 degrees of difficulty: A 3 degree of difficulty, or par 3, is allocated 9 minutes to play 18, a par 4 is allocated 12 minutes to play 19 and a par 5 is allocated 15 minutes to play 20. Each wedge on the decal is sized to represent 9 minutes 18, 12 minutes 19 or 15 minutes 20. Each wedge corresponds to a hole on the golf course. Each hole on the golf course is numbered 1 though 18. The decal begins with wedge 1 at the 12:00 position and proceeds in numerical order through wedge 18 or the 18^{th} hole. Golf course management assigns the par for each hole and the decal illustrates the time allocated for each hole with wedges widths on the decal equal to 9 minutes 12 minutes or 15 minutes. To make it easy for the golfers to follow, the hole numbers 21 are listed on each wedge. The clock hand floating indicator 4 rotates clockwise around the decal, starting at the 12:00 position and ending at the 12:00 position. Excess space 22 after wedge 18 or 18^{th} hole, and before the clock hand returns to the 12:00 position, can be used for a course logo 22. The space in the center 23 can be used for course logo or sporting company logo.

FIG. 3 The inner cover glass 14 is 0.050″ thick plate glass. The thin glass will reduce the weight of the timer quite a bit, and will increase visibility of the dial. This cover is carried by a second, larger bezel 15. The bezel will slide down over a standard O-ring and be fastened in place using 8 screws which are inserted from the back. It is removable for service of the timer should that be needed, but is not so convenient to do while out on the course. The bezel creates an effective viewable diameter of the dial of approximately 4 5/16 inches.

FIG. 1 and FIG. 3 The floating indicator will be red 4, painted onto the surface of a 0.01″ thick polycarbonate disk 13. The disk is thin to reduce the load being driven by the clock movement. It will also improve visibility. The outer edge of this disk will rotate under a recess in the glass bezel. By covering the outer edge of the transparent disk, the disk becomes nearly invisible from the front, and this will cause the indicator to appear to float above the dial 12. The use of the disk removes the need for any sort of stick style hand which would obviously be carried by a center hub. The transparent disk will be mounted on a plastic hub 7 which is the same color as the dial. This will make the hub less noticeable.

The dial 12 will be 1/32 to 1/16 thick plastic that may include white acetal plastic, or an outdoor grade of the type of plastic. The dial will be a solid low sheen surface. The surface may contain a logo.

The strap 1 material itself can be leather with a loop sewn into the anchored end, or it could be a rubber, perhaps neoprene or polyurethane, in which case the loop would be cemented. The free end will be provided with a keyhole shaped hole which is sized to fit the post on the back of the case. The loop will be sized with enough slack to allow the insertion of the strap bail and post 2.

This will allow the strap to be removed and replaced as needed due to wear. The strap bail and post 2 are stainless steel and attached to the case with stainless steel screws. The Timer may be carried by individual golfers and/or carried on golf carts and/or carried on the golf bag and/or pull-cart being used by the golfer(s).

Golfers are advised that they must complete their golf game during within the allotted game time or face excessive penalty fees and/or be banned from playing the course for a specified amount of time all determined by the golf course management.

The Timer provides a consistent and impersonal “authority” for the control of play and gives a course marshal information upon which to base fair and consistent decisions about asking players to play faster to keep pace with the Timer.

The above disclosure is not intended as limiting. Those skilled in the art will readily observe that numerous modifications and alterations of the device may be made while retaining the teachings of the invention. Accordingly, the above disclosure should be construed as limited only by the restrictions of the appended claims.

I claim:

1. A Golf Round Pace Regulator timing device (“Timer”) for use by golfers and golf course agents to illustrate the amount of time allocated to each hole by the golf course management in order for golfers to complete the entire course at a steady pace in the time allotted by the golf course management. The golfer(s) are then responsible for keeping the same pace on the course as the pace of the Timer's moving clock hand. The timer comprising:
a timing mechanism for operating to measure passage of time;
a timer dial connected to the timing mechanism, having 5 surfaces; the base dial inside surface, over laid with a rotating floating clock hand indicator, then a screwed on glass surface, a cling static decal with course hole markings and finally the outer surface being a durable poly-carbonate clear plastic.
a starting means connected to and cooperating with the timing mechanism and accessible with key by the golf course attendant for resetting the Timer and starting operation of the timing mechanism to coincide with the golfer's start of play; and
a cling static decal with course hole markings placed on the clear glass surface and covered with the outer layer clear poly-carbonate plastic surface so the decal is visible to the golfer to indicate the hole of the golf course that the golfer should be playing at the time measured by the timing mechanism.

2. A Timer as set forth in claim 1, wherein the cling static decal hole markings comprises:
a series of wedges of hole markings on the cling static decal placed on the glass surface of the Timer face, each hole marking corresponding to an individual golf course hole; and
a clock hand pointing means that is a clear rotating disk with an arrow attached near the perimeter to give the appearance of a floating hand that is connected to the timing mechanism interior surface. The floating hand points to the hole markings on the cling static decal attached to the glass surface, the clock hand being driven by the operation of the timing mechanism to sweep across the interior surface to point to the hole markings;
wherein the hole markings are arranged on the cling stick decal placed on the glass surface so that the clock hand points to each hole marking at the time the golfer should be playing the corresponding golf course hole.

3. A Timer as set forth in claim 1, wherein the hole indicator comprises:
a plurality of hole markings on the cling static decal on the glass surface of the timer face, each hole marking corresponding to an individual golf course hole; and
a clear poly-carbonate plastic exterior attached to a bezel cover snapped to the timing mechanism and extending across the timer case exterior surface over the hole markings;
wherein the hole markers are arranged on the cling static decal surface so that the clock hand pointing means sweeps under each hole marker at a time at which the golfer should be playing the corresponding golf course hole.

4. A Timer for use by golfers and golf course agents to illustrate to the golfers the time allocated for each golf course hole, the timer comprising:
a timing mechanism for operating to measure passage of time;
a timer dial connected to the timing mechanism, having 5 surfaces; the base dial inside surface, over laid with a rotating floating clock hand indicator, then a screwed on glass surface, a cling static decal with course hole markings and finally the outer surface being a durable poly-carbonate clear plastic.
a starting means connected to and cooperating with the timing mechanism and accessible with key by the golf course attendant for resetting the Timer and starting operation of the timing mechanism to coincide with the golfer's start of play; and
a cling static decal with course hole markings placed on the clear glass surface and covered with the outer layer clear poly-carbonate plastic surface so the decal is visible to the golfer to indicate the hole of the golf course that the golfer should be playing at the time measured by the timing mechanism;
a clock hand pointing means that is a clear rotating disk with an arrow attached near the perimeter to give the appearance of a floating hand that is connected to the timing mechanism interior surface. The floating hand points to the hole markings on the cling static decal attached to the glass surface, the clock hand being driven by the operation of the timing mechanism to sweep across the interior surface to point to the hole marking wedge;
wherein the wedges are arranged on the cling static decal attached to the glass surface so that the pointing means points to each wedge at the time at which the golfer should be playing the corresponding golf course hole.

5. A golf course timer as set forth in claim 4, wherein the pointing means comprises a clock hand pointer on a clear disk.

6. A golf course timer as set forth in claim 4, wherein the pointing means is under the glass surface, the cling static decal is on the glass surface, where the pointer is visible through which each wedge is visible through the top poly-carbonate plastic cover attached to a bezel.

7. A golf course timer to solve the problems of decreased golf course revenues resulting from slow play on the golf course. Solving the slow play problem allows golf management to start players at their scheduled Tee Times thereby maximizing golfers on the golf course and maximizing golf course revenue.

8. A golf course timer that has a universal design that can be manufactured cost effectively and easily customized for each golf course post manufacturing phase with the use of the custom course cling static decal.

9. A golf course timer that prevents tampering with the timing mechanism.

10. A golf course timer that is water resistant and rigid enough to withstand varying outdoor temperatures.

11. A golf course timer that has a case that seals the timing mechanism and moveable parts thereby restricting access to the parts and then securing the accuracy of the timer.
